(19) United States
(12) Patent Application Publication
(10) Pub. No.: US 2026/0301038 A1
(43) Pub. Date: Oct. 1, 2026

(54) Swipe-Based User Interface for Personalized Style Generation

(71) Applicant: eBay Inc., San Jose, CA (US)

(72) Inventors: Matthew Kyle Gearhart, Portland, OR (US); Haggai Roitman, Yokneam Ilit (IL)

(73) Assignee: eBay Inc., San Jose, CA (US)

(21) Appl. No.: 19/094,953

(22) Filed: Mar. 30, 2025

(51) Int. Cl. G06Q 30/0601; G06F 3/04817; G06F 3/04845; G06F 40/20

(52) U.S. Cl. CPC G06Q 30/0621; G06F 3/04817; G06F 3/04845; G06F 40/20; G06Q 30/0643

(57) ABSTRACT

Swipe-based personalized style generation is described. A personalization system presents different instances of digital content along with configurable aspect options in a swipeable user interface. Users provide detailed feedback through swipe gestures or other inputs to indicate interest or disinterest in both the overall item and specific attributes represented by configurable aspect options displayed in the swipeable user interface. Based on this input, the personalization system generates weighted aspects for each configurable option of an item. Using this weighted information, the personalization system creates a comprehensive representation of user preferences and leverages it to generate a personalized style for the user. This personalized style is used to identify and present new instances of digital content tailored to the user's preferences across various digital platforms.

### BACKGROUND

With the continuous development of computing device technologies, the availability of information, data media, and other content on digital platforms (e.g., digital marketplaces), continues to increase. This growing influx of digital content provides users with an unprecedented variety of choices. However, it is challenging for a user to efficiently navigate the ever-growing number of options to arrive at digital content of genuine interest. As users attempt to sift through a large volume of options, computing device resources (e.g., processing power, memory, network bandwidth, etc.) are often needlessly expended, leading to inefficiencies and wasted computational capacity. Thus, there remains a need to present digital content in a manner that optimizes computational resource usage.

### SUMMARY

Swipe-based personalized style generation is described. A personalization system presents different instances of digital content (e.g., images depicting items for sale on a digital marketplace, artwork, audio, video, etc.) in a swipeable user interface. In some implementations, the different instances of digital content are selected by the personalization system based on previous user interactions across various digital platforms, such as e-commerce marketplaces, digital media streaming services, and library systems. The instances of digital content are presented in the swipeable user interface along with configurable aspect options for the digital content, prompting users to provide detailed feedback through swipe gestures or other inputs to indicate interest or disinterest in both the overall item and item-specific attributes.

Based on the input indicating preferences for each instance of digital content and its configurable aspects, a feedback encoding is generated and provided to the personalization system. The personalization system processes this feedback to generate weighted aspects, assigning weights to each configurable aspect option for the presented digital content. This weighted information is then used to create a comprehensive representation of user preferences across multiple items and their attributes. The personalization system leverages this encoded feedback to generate a personalized style for the user from which the favorable or unfavorable indications were received.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the swipe-based personalized style generation techniques described herein.

FIG. 2 depicts a system in an example implementation showing operation of the personalization system of FIG. 1 in greater detail as generating a feedback encoding based on input to the swipeable user interface.

FIG. 3 depicts a system in an example implementation of a swipeable user interface receiving user input.

FIG. 4 depicts a system in an example implementation of receiving user input to the swipeable user interface and modifying the swipeable user interface based on the user input.

FIG. 5 depicts a system in an example implementation of receiving user input to the swipeable user interface and modifying the swipeable user interface based on the user input.

FIG. 6 depicts a system in an example implementation of receiving user input to the swipeable user interface and modifying the swipeable user interface based on the user input.

FIG. 7 depicts a system in an example implementation of receiving user input to the swipeable user interface and modifying the swipeable user interface based on the user input.

FIG. 8 depicts a system in an example implementation of receiving user input to the swipeable user interface and modifying the swipeable user interface based on the user input.

FIG. 9 depicts a system in an example implementation showing operation of the personalization system of FIG. 1 in greater detail as generating a personalized style based on user input to the swipeable user interface.

FIG. 10 depicts a system in an example implementation showing operation of a prompt generation module in greater detail as generating a prompt based on weighted item aspects represented in a feedback encoding generated based on feedback to a swipeable user interface.

FIG. 11 depicts a system in an example implementation showing output of a user interface as displaying at least one item of a personalized style generated by the personalization system of FIG. 1.

FIG. 12 depicts a procedure in an example implementation of generating a personalized style based on user input to a swipeable user interface.

FIG. 13 depicts a procedure in an example implementation of generating a personalized style based on user input to a swipeable user interface.

FIG. 14 illustrates an example system including various components of an example device that can be implemented as any type of computing device as described and/or utilize with reference to the previous figures to implement the techniques described herein.

### DETAILED DESCRIPTION

### Overview

To assist users in discovering content of genuine interest, conventional recommendation systems gauge user interest in different content and use the gauged interest to recommend items that are likely of interest to a user. Conventional systems, however, struggle to accurately gauge user interest in different items, relying on limited behavioral signals and ineffective feedback mechanisms. Conventional approaches frequently misinterpret user actions, such as page views, clicks, or purchases, which may not necessarily reflect true user intent or interest. For instance, a high number of views for a digital content item may indicate curiosity rather than genuine interest, while clicks may result from an engaging thumbnail rather than a meaningful desire to interact further with the digital content item. Even purchases, while a strong indicator of user interest, do not account for cases where users abandon their carts due to external factors such as price sensitivity, limited availability, and so forth. As a result, users are often presented with irrelevant content, causing frustration and wasted time as they navigate through vast amounts of digital content across various platforms and digital environments.

To address these technical challenges facing conventional systems, a “swipeable” user interface (e.g., an interface configured to receive swipe-based user input) for personalized style generation is described. In implementations, a personalization system presents digital content items to users within the swipeable user interface. This interface may be implemented across various digital platforms, including e-commerce marketplaces, digital media streaming services, library systems, and so forth. In the swipeable user interface, each item is displayed along with configurable aspect options, allowing users to provide detailed feedback on specific attributes that contribute to their interest or disinterest in the item. For instance, in an example e-commerce setting, the swipeable user interface displays different color options, patterns, materials, and so forth for a given clothing item.

Users interact with the swipeable interface via various inputs, such as simple swipe gestures, indicating their preferences for an item in general, and optionally preferences with respect to one or more specific configurable aspects of the item. This granular feedback mechanism enables a personalization system to capture nuanced user preferences without requiring extensive user effort. Via input to the swipeable user interface, users can drag or swipe from an item towards visual hints representing configurable aspect options, explicitly indicating which options contributed to user interest or disinterest. In implementations, the swipeable interface is dynamically update to present different configurable aspect options for the same item, or transition to new items with its respective configurable aspect options, based on user interactions. For instance, if a user expresses disinterest in configurable aspect options that are initially presented, the personalization system is configured to re-present the item with different configurable aspect options to explore potential combinations that might appeal to the user.

Based on feedback received via input to the swipeable user interface, the personalization system generates weighted item aspects, assigning weights to each configurable aspect option for at least one item. This weighted information is then used to create a feedback encoding that succinctly represents user preferences across multiple items and their attributes. Leveraging this encoded feedback, the personalization system generates a personalized style for a user, which includes new instances of digital content that align with the user's preferences. In some implementations, the personalization system is configured to generate the personalized style by constructing a prompt for a machine learning model, such as a large language model (LLM). The prompt instructs the LLM to generate a personalized style for the user by analyzing the liked and disliked items, along with explicitly liked configurable aspect options. The LLM identifies new items that align with the user's preferences based on the prompt.

In some implementations, the personalization system advantageously pre-generates personalized styles for all possible combinations of feedback encodings that may be generated based on user feedback to a pre-defined sequence of items and respective configurable aspect options that are displayed for each item in the swipeable user interface. Advantageously, generating personalized styles in advance of receiving a feedback encoding from a user device enables the personalization system to retrieve personalized styles in real time from a style database without the need for computationally intensive operations typically associated with conventional search and recommendation algorithms. By avoiding on-the-fly complex computations and extensive database queries, the personalization system significantly reduces computational overhead, optimizes resource usage, and enhances the performance of both server-side and client-side computing devices.

The described techniques thus provide a more accurate and efficient method for capturing user preferences and generating personalized styles based on feedback in the form of user input to a swipeable user interface. By enabling users to provide detailed feedback on specific configurable aspect options for a given item, the personalization system addresses the limitations of conventional binary feedback (e.g., “like” or “dislike”) mechanisms. This approach optimizes computational resources by focusing on relevant item attributes and reduces the need for extensive data collection and analysis associated with conventional personalization systems. Moreover, the intuitive swipe-based interface enhances user engagement and satisfaction, leading to more accurate preference data and more relevant recommendations across various platforms and digital content types. Further discussion of these and other examples is included in the following description and illustrated with respect to the corresponding figures.

In the following discussion, an example environment is described that is configured to employ the techniques described herein. Example procedures are also described that are configured for performance in the example environment as well as other environments. Consequently, performance of the example procedures is not limited to the example environment and the example environment is not limited to performance of the example procedures.

### Example Environment

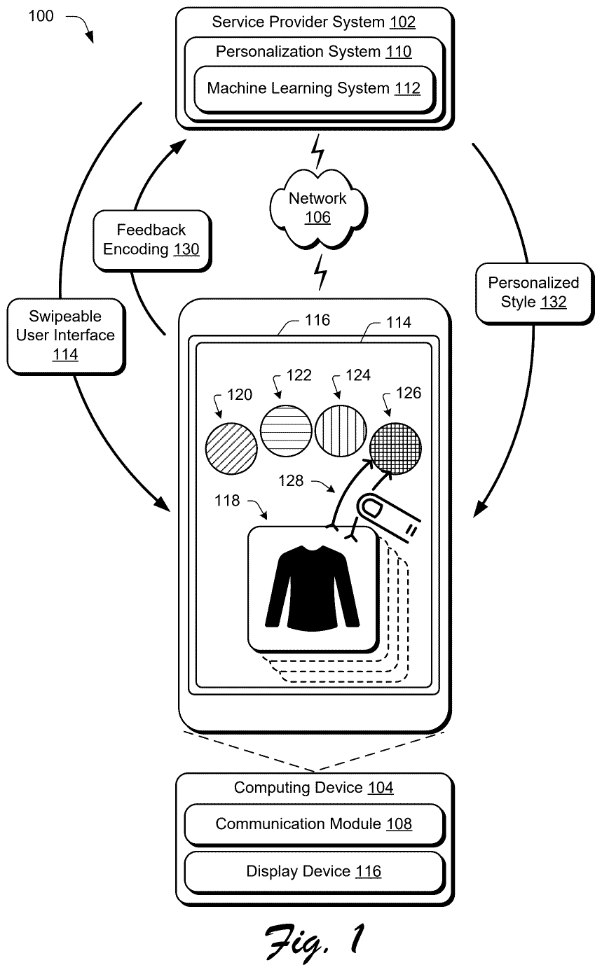

FIG. 1 is an illustration of a digital medium environment 100 in an example implementation that is operable to employ the swipe-based personalized style generation techniques described herein. The illustrated environment 100 includes a service provider system 102 and a computing device 104 that are communicatively coupled, one to another, via a network 106. Computing devices, such as one or more computing devices represented by the service provider system 102 and/or the computing device 104, are configurable in a variety of manners.

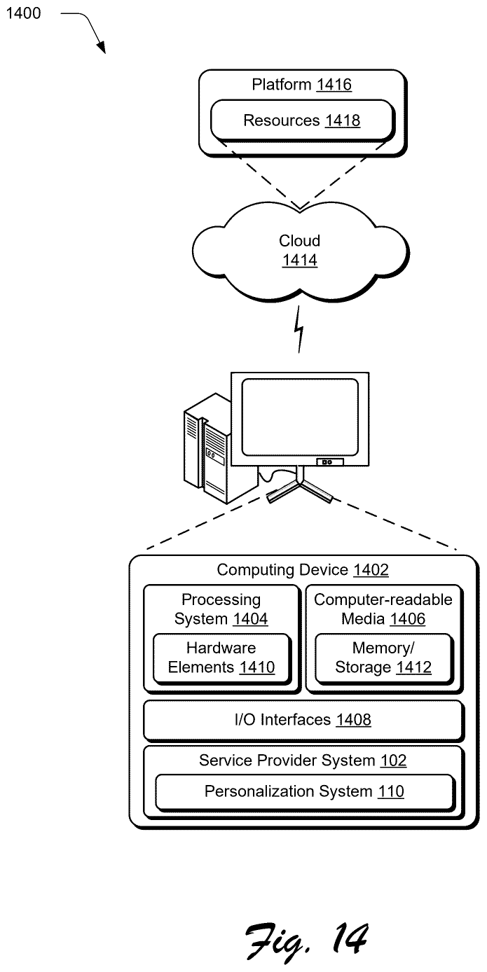

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by an entity to perform operations “over the cloud” for the service provider system 102 and as further described in relation to FIG. 14.

The service provider system 102 is representative of a combination of hardware and software resources (e.g., instructions stored on a computer-readable storage medium that are executed by at least one processing device) to provide digital services (e.g., digital services that are remotely available to the computing device 104 via the network 106). As an example, a digital service offered by the service provider system 102 includes a digital marketplace platform, such as a cloud-based, modular architecture that enables secure and scalable transactions between buyers and sellers of products or services listed for sale via digital marketplace listings.

In implementations, such digital services offered by the service provider system 102 are built on microservices that handle various digital marketplace functions such as user authentication, item listing management, payment processing, order fulfillment, and so forth. In some implementations, digital services offered by the service provider system 102 are extendable to third-party integrations, such that functionality of the service provider system 102 is integrated or otherwise extended to other digital services. As described in further detail below with respect to FIG. 14, the service provider system 102 is representative of a distributed data storage system, which is configured to ensure fault tolerance and implements encryption protocols to protect sensitive user data, transaction data, and so forth.

In the specific example context of a digital marketplace service provided by the service provider system 102, the service provider system 102 incorporates search and recommendation algorithms to personalize an experience of a user interfacing with the digital marketplace of the service provider system 102. Continuing this example context of a digital marketplace service, the service provider system 102 implements an access control system to ensure that certain resources are restricted to authorized entities, provide analytics to marketplace activity, and so forth.

In the illustrated example of FIG. 1, computing device 104 includes a communication module 108 to access digital services (e.g., via the network 106) offered by the service provider system 102. The communication module 108, for instance, is representative of a browser configured to access a digital marketplace of the service provider system 102 via the Internet, an application provided by the service provider system 102, combinations thereof, and so forth. The communication module 108 is thus representative of functionality of the computing device 104 to communicate data to, and receive data from, the service provider system 102.

The service provider system 102 is depicted as including a personalization system 110. Although illustrated and described herein as being implemented at the service provider system 102, in some implementations the personalization system 110 is implemented locally at the computing device 104. The personalization system 110 implements a machine learning system 112 and is configured to generate a personalized style for at least one user based on feedback to a swipeable user interface 114. As described in further detail below, the swipeable user interface presents digital content items, along with configurable aspect options for each digital content item, in a manner that allows users to provide detailed feedback regarding digital content items via intuitive swipe gestures. Via the swipeable user interface 114, users can indicate their preferences for both the overall item and specific attributes by swiping or dragging towards visual representations of different configurable aspect options.

Although described below with respect to specific examples of digital content items and specific configurable aspects for each of the digital content items, the described examples are not limiting and the techniques described herein extend to any type of digital content item that is defined by attributes including any combination of configurable aspects and options thereof. For instance, in implementations where a digital content item represents a clothing item, configurable aspects of the clothing item include color, pattern, material type, size, and so forth, where each configurable aspect is limited by one or more options (e.g., different colors, different patterns, different material types, different sizes, etc.) to collectively define the clothing item.

As another example, in implementations where a digital content item represents artwork, configurable aspects of the artwork include style, medium, subject matter, color palette, and so forth, where each configurable aspect is limited by one or more options (e.g., different styles, different mediums, different subjects, different color schemes, etc.) to collectively define the artwork. As another example, in implementations where a digital content item represents audio content, configurable aspects of the audio include genre, tempo, instrumentation, vocal style, and so forth, where each configurable aspect is limited by one or more options (e.g., different genres, different tempos, different instruments, different vocal techniques, etc.) to collectively define the audio content. As another example, in implementations where a digital content item represents video content, configurable aspects of the video include genre, length, visual style, narrative structure, and so forth, where each configurable aspect is limited by one or more options (e.g., different genres, different durations, different cinematographic techniques, different storytelling approaches, etc.) to collectively define the video content.

In the illustrated example of FIG. 1, the service provider system 102 is depicted as including a display device 116. The display device 116 is representative of hardware configured to output visual information to one or more users of the computing device 104. For instance, the display device 116 is representative of a monitor (e.g., an external screen connected to and optionally integrated into a form factor of the computing device 104). Alternatively or additionally, the display device 116 is representative of a touchscreen that functions both to output visual information and receive input from a user of the computing device 104. Alternatively or additionally, the display device 116 is representative of a projector configured to display visual information on relatively large surfaces. Alternatively or additionally, the display device 116 is representative of a wearable device (e.g., a virtual reality headset) that immerses a user of the computing device 104 in a digital environment. Other examples are contemplated in accordance with the described techniques, such that the display device 116 is representative of a range of different display sizes, resolutions, and configurations for outputting visual information on behalf of the computing device 104.

The display device 116, for instance, outputs a display of the swipeable user interface 114 via the computing device 104. In the illustrated example of FIG. 1, the swipeable user interface 114 is depicted as displaying an item 118, illustrated as a long-sleeved shirt. The item 118 represents an instance of digital content presented as part of a sequence (e.g., a deck of cards), where each card in the deck corresponds to an instance of digital content. In some implementations, the item 118 and subsequent items presented in the swipeable user interface 114 are populated by the personalization system 110 based on past interactions between the computing device 104 and the service provider system 102. For instance, the personalization system 110 selects items for presentation in the swipeable user interface 114 based on previous user interactions across various digital platforms, such as e-commerce marketplaces, digital media streaming services, library systems, combinations thereof, and so forth.

The swipeable user interface 114 is further depicted as displaying configurable aspect options positioned relative to the item 118. For instance, the illustrated example of FIG. 1 depicts configurable aspect option 120, configurable aspect option 122, configurable aspect option 124, and configurable aspect option 126 for item 118. Specifically, the illustrated example of FIG. 1 depicts different options for a pattern attribute of the long sleeve shirt represented by item 118. The configurable aspect options displayed by the swipeable user interface 114 thus represent different attributes of the item 118 and are configured to allow users to provide detailed feedback on specific attributes that contribute to user interest or disinterest in the item 118.

In implementations, the configurable aspect option 120, configurable aspect option 122, configurable aspect option 124, and configurable aspect option 126 are positioned in a manner that prompts input in the form of a directional swipe gesture to move from the item 118 towards one of the configurable aspect options. Although illustrated in FIG. 1 as being positioned at an example display arrangement in the swipeable user interface 114, the described techniques are not so limited. For instance, configurable aspect options for an item 118 are displayable in any suitable layout or arrangement, using any suitable representation for a respective configurable aspect option. In some implementations, each configurable aspect option is displayed in the swipeable user interface 114 at a uniform (e.g., the same or approximately the same) distance from the item 118. Such uniform spacing for configurable aspect options advantageously avoids a scenario where user input is ambiguous as which configurable aspect option is intended to be selected.

The illustrated example of FIG. 1 depicts an example scenario where user input 128 is received at the swipeable user interface 114 in the form of a directional swipe gesture that moves from the item 118 towards one of the configurable aspect options (e.g., indicating interest in a specific attribute of the long-sleeved shirt represented by the item 118, such as a gingham pattern). This user input 128 is thus representative of a single swipe gesture which indicates that a user of the computing device 104 is interested in the item 118, and specifically interested in the item 118 having a pattern represented by configurable aspect option 126.

In some implementations, the directional swipe gesture of the user input 128 moves the card depicting the item 118 off the top of the deck of cards (e.g., towards a configurable aspect option representation), which causes the deck of cards to reveal an additional digital content item. Various descriptions of how user input 128 to the swipeable user interface 114 is useable to indicate feedback relative to configurable aspect options for an item, and resulting swipeable user interface 114 changes, are provided in further detail below.

Based on the user input 128 to the swipeable user interface 114, the computing device 104 generates feedback encoding 130. The feedback encoding 130 represents a structured data format that captures both positive and negative sentiment with respect to discrete configurable aspect options for the item 118, such as color, pattern, material, or style options for a clothing item displayed in an e-commerce marketplace. Specifically, the computing device 104 generates values for inclusion in the feedback encoding 130 based on the user's interactions with the configurable aspect options (e.g., one or more of configurable aspect option 120, configurable aspect option 122, configurable aspect option 124, or configurable aspect option 126).

For example, if the user swipes from the item 118 towards a specific configurable aspect option, the computing device 104 generates a positive value associated with that option in the feedback encoding 130. Conversely, if the user swipes away from a configurable aspect option, a negative value is included in the feedback encoding 130. In implementations, the feedback encoding is generated using various data formats to represent preferences expressed by user input 128, such as numerical scales (e.g., −5 to +5), categorical labels (e.g., “strongly dislike”, “neutral”, “strongly like”), percentages, combinations thereof, and so forth.

In implementations, the feedback encoding 130 is generated in a format defined by requirements of the personalization system 110. For instance, in an example implementation the feedback encoding 130 is structured as a JavaScript Object Notation (JSON) object, where each configurable aspect option is a key with an associated sentiment value. Alternatively or additionally, the feedback encoding 130 is formatted as a comma-separated string of aspect-sentiment pairs, as a multi-dimensional array representing different aspects and their corresponding sentiment scores, combinations thereof, and so forth.

As described in further detail blow, various techniques are useable to generate the feedback encoding 130. As a specific example, a sliding scale algorithm is used to translates the distance and direction of the user's swipe into a numerical sentiment score that accounts for configurable aspect options of a given item. Alternatively or additionally, machine learning models are leveraged to generate the feedback encoding 130 based on swipe characteristics of user input 128. Alternatively or additionally, a rule-based approach that maps specific swipe gestures to defined elements of the swipeable user interface 114 is used to generate the feedback encoding 130.

In response to generating a feedback encoding 130 that includes a threshold number of interactions (e.g., a threshold number of swipe gestures represented by user input 128) or covers a specified set of configurable aspect options for one or more items, the communication module 108 communicates the feedback encoding 130 to the service provider system 102 via the network 106. In implementations, thresholds that trigger transmission of the feedback encoding 130 to the service provider system 102 are defined by the service provider system 102, or it could be dynamically adjusted based on user behavior patterns. Alternatively, the user may explicitly indicate completion of their feedback session through a specific gesture or control in the swipeable user interface 114 (e.g., indicating that a user of the computing device 104 is done with classifying the item 118).

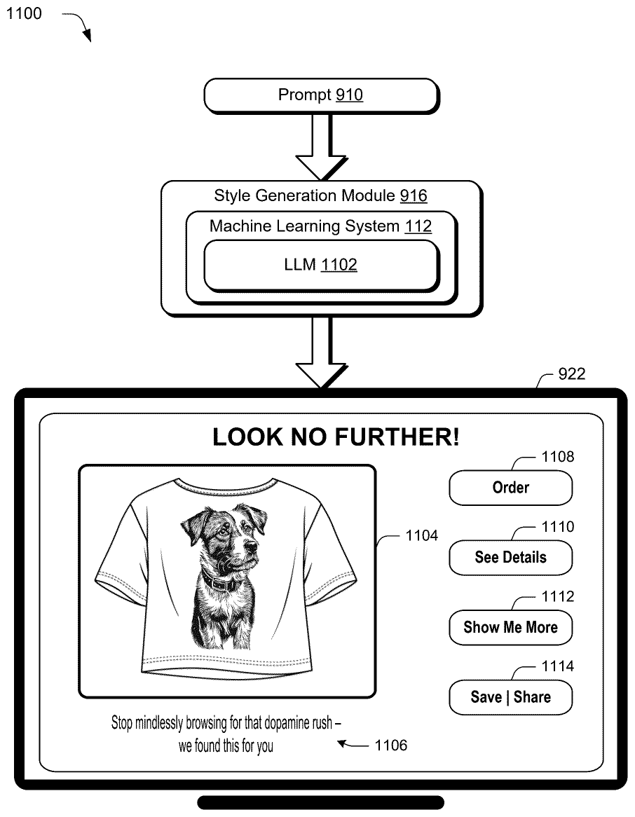

As described in further detail below, the personalization system 110 leverages the machine learning system 112 to generate a personalized style 132 for a user of the computing device 104 based on the feedback encoding 130. The personalized style 132 is communicated from the service provider system 102 to the computing device 104 (e.g., for display in the swipeable user interface 114 or in a different user interface). An example of a personalized style 132 as output by the personalization system 110 is described in further detail below with respect to FIG. 11. In implementations, the personalized style 132 includes at least one additional item of digital content that was not included in the deck of cards from which the feedback encoding 130 was generated. The machine learning system 112 is configured to identify this additional item of digital content based on the feedback encoding 130, and does so with an objective of finding an additional item of digital content that is likely to be of interest to a user of the computing device 104.

In implementations, the machine learning system 112 is pre-trained to generate a style database that includes a personalized style for each possible combination of values in a feedback encoding 130 that can be returned for a sequence of digital content items displayed in the deck of cards via the swipeable user interface 114. In implementations, the machine learning system 112 is configured to generate a style database that includes different personalized styles 132, where each entry in the database is indexed by a corresponding set of values represented by each possible feedback encoding 130. In such implementations, the machine learning system 112 identifies the personalized style 132 by indexing the style database using a received feedback encoding 130, thus returning a personalized style 132 to the computing device 104 in real time, which is not possible using conventional techniques.

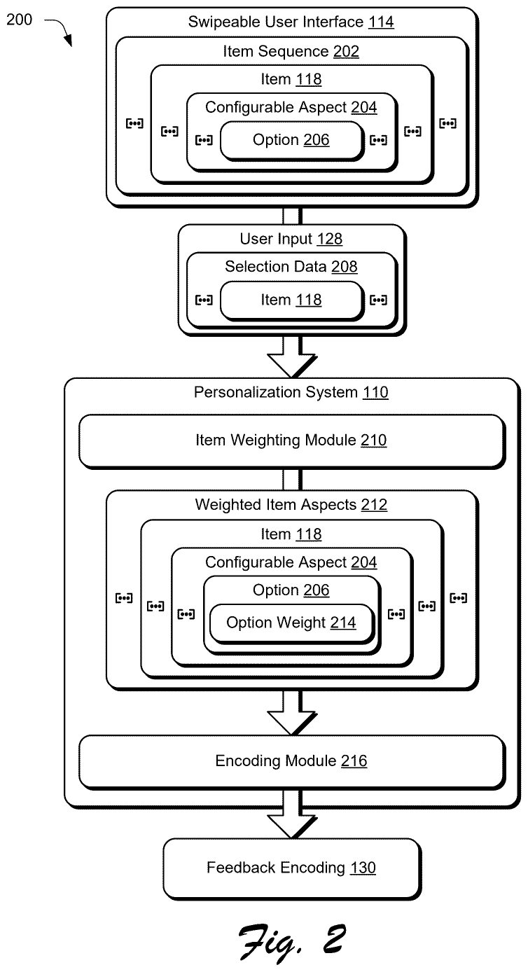

Thus, in contrast to conventional service provider systems, which identify items of potential interest by executing a search query that requires significant consumption of computational resources (e.g., high processing device usage, querying of large datasets that exceeds available memory thresholds, retrieving data from disk-based storage, bottlenecking available communication channel bandwidth, etc.), the described techniques identify and return a personalized style 132 in real time using minimal computational resources. Advantageously, the described techniques thus improve performance of one or more computing devices implementing the personalization system 110 by avoiding unnecessary computations and improve an experience of a user of the computing device 104 when interacting with the service provider system 102 via the swipeable user interface 114. For a further description of generating the feedback encoding 130 based on input to the swipeable user interface 114, consider FIG. 2.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Personalized Style Generation From Swipe-Based Interface Input

FIG. 2 depicts a system 200 in an example implementation showing operation of the personalization system 110 in greater detail as generating feedback encoding 130 based on input to the swipeable user interface 114. In the illustrated example of FIG. 2, the swipeable user interface 114 includes an item sequence 202. The item sequence 202 represents functionality of the swipeable user interface 114 to present a series of digital content items in a defined order, such as a deck of cards where each card corresponds to an instance of digital content. The item sequence 202 is thus representative of a sequence of items that includes the item 118. Individual items of the item sequence 202 are defined by at least one configurable aspect 204, which represents attributes of the item that can be customized or selected. For instance, each configurable aspect 204 is associated with at least two options 206. For example, in the context of a clothing item, configurable aspects 204 include color, pattern, and material, with each configurable aspect having multiple options 206 to choose from.

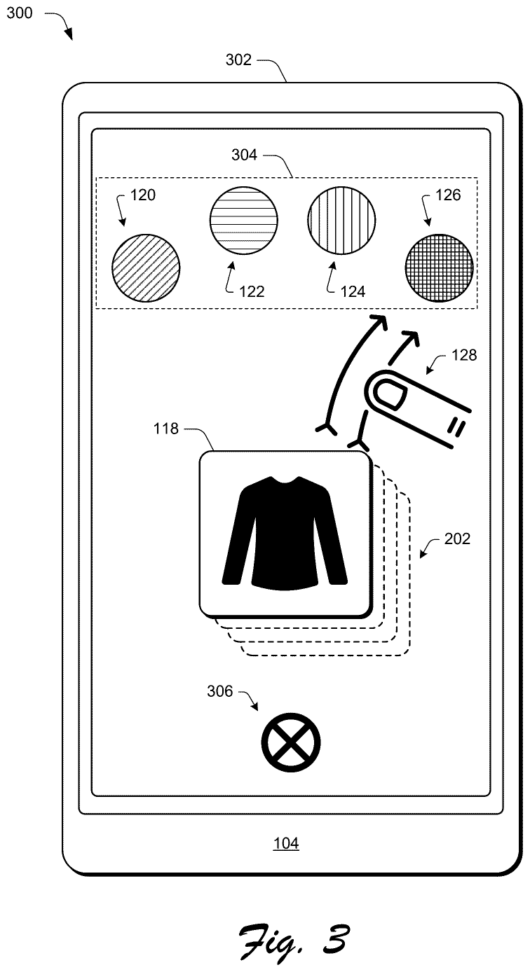

The swipeable user interface 114 is configured to receive user input 128. In implementations, the user input 128 is received (e.g., at the computing device 104) in the form of swipe gestures or other interactions that indicate a user's preference for the item 118 and its configurable aspect options. Based on the user input 128, the computing device 104 generates selection data 208. The selection data 208 captures the user's interactions with the item 118 and its configurable aspect options, representing the user's interest or disinterest in an item 118 as well as interest or disinterest in specific options 206 for different configurable aspects 204 of the item 118. For a further description of user input 128 received at the swipeable user interface 114, consider FIGS. 3-8.

FIG. 3 depicts a system 300 in an example implementation of the swipeable user interface 114 receiving user input 128. In the illustrated example of FIG. 3, the computing device 104 displays a configuration 302 of the swipeable user interface 114. The configuration 302 includes a configurable aspect option region 304, which includes multiple configurable aspect options shown as circular elements with different patterns. In the illustrated example of FIG. 3, the configurable aspect option region 304 is depicted as a horizontal row at the top of the interface in this example. However, this arrangement is not limiting, and any suitable layout or positioning of configurable aspect options is contemplated within the scope of the described techniques. For instance, in some implementations, configurable aspect options may be arranged vertically, in a grid pattern, or dynamically positioned based on user interaction or orientation of the computing device 104. The swipeable user interface 114 includes a display of item 118 as part of the item sequence 202.

In the illustrated example of FIG. 3, the user input 128 depicts a scenario where the user indicates interest in the item 118 and specifically interest in the item 118 with a gingham pattern as represented by the configurable aspect option 126. This user input 128 is thus representative of a single swipe gesture which indicates that a user of the computing device 104 is interested in the item 118, and specifically interested in the item 118 having a pattern represented by configurable aspect option 126.

At the bottom of the display, a negative feedback indicator 306 is shown as a circular icon with an “X” symbol. The negative feedback indicator 306 represents an optionally displayed component of the swipeable user interface 114. It provides a mechanism for user input 128 to indicate disinterest in the item 118 and/or specific configurable aspect options of the item. For example, a user may swipe towards the negative feedback indicator 306 to express dislike for the current item or its attributes, allowing for more nuanced feedback relative to conventional systems.

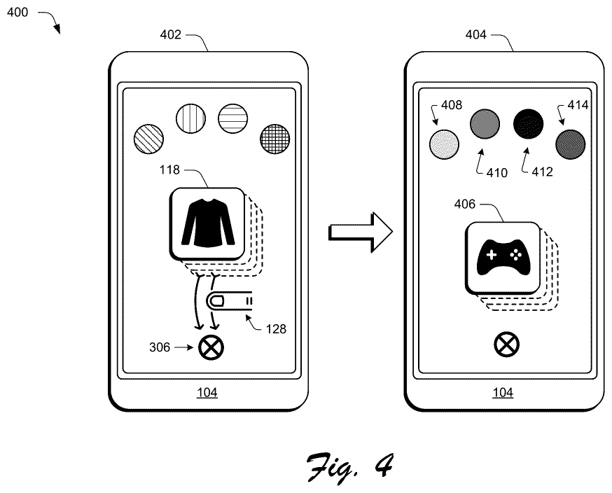

FIG. 4 depicts a system 400 in an example implementation of receiving user input 128 to the swipeable user interface 114 and modifying the swipeable user interface 114 based on the user input 128. In the illustrated example of FIG. 4, computing device 104 is depicted as outputting a first configuration 402 and a second configuration 404 of the swipeable user interface 114. In the first configuration 402, the computing device 104 displays an item 118 and depicts a scenario where user input 128 indicates disinterest in the item 118 via the negative feedback indicator 306. Output of the second configuration 404 is triggered in response to the user input 128 at the first configuration 402 of the swipeable user interface 114.

The second configuration 404 thus depicts a result of the user input 128 indicating disinterest in the item 118 via the negative feedback indicator 306. In the second configuration 404, the computing device 104 displays an additional item 406 represented by a gaming controller icon. This additional item 406 replaces the previous item 118, representing a next item in the item sequence 202. The configurable aspect option region 304 is updated in the second configuration 404 to include corresponding configurable aspect options for the item 406, represented by configurable aspect option 408, configurable aspect option 410, configurable aspect option 412, and configurable aspect option 414. These configurable aspects options may represent different colors or attributes specific to the video game controller represented by additional item 406.

In the illustrated example of FIG. 4, the swipeable user interface 114 maintains consistent positioning of elements between configurations, with the main item display area in the center and configurable aspect options arranged along the top of the screen. The negative feedback indicator 306 remains at the bottom of the display in both configurations, providing a consistent mechanism for expressing user preferences relative to different items and their respective configurable aspect options. This transition from the first configuration 402 to the second configuration 404 demonstrates how the swipeable user interface 114 dynamically updates to present new items and their associated configurable aspects based on user input, allowing for continuous feedback collection and personalization.

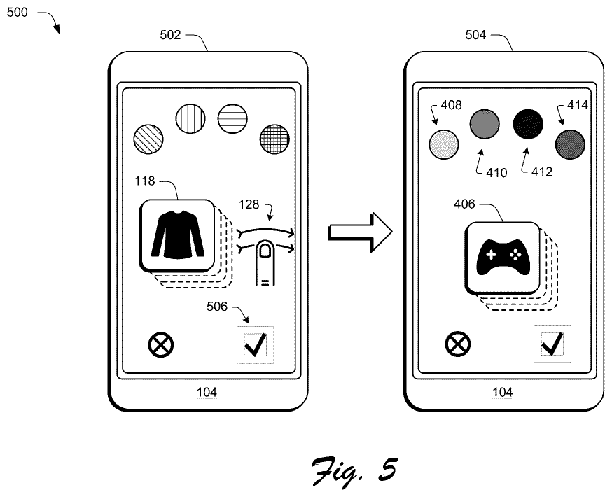

FIG. 5 depicts a system 500 in an example implementation of receiving user input 128 to the swipeable user interface 114 and modifying the swipeable user interface 114 based on the user input 128. In the illustrated example of FIG. 5, computing device 104 is depicted as outputting a first configuration 502 and a second configuration 504 of the swipeable user interface 114. In the first configuration 502, the computing device 104 displays an item 118 and receives user input 128 relative to the item 118. The first configuration 502 introduces a positive feedback indicator 506, shown as a checkmark symbol, in contrast to the negative feedback indicator 306. These indicators provide users with clear mechanisms for expressing both positive and negative sentiment towards items and their configurable aspects.

Specifically, in the first configuration 502, user input 128 expresses interest in the item 118 without selecting any specific configurable aspect options. The input may be in a direction related to a positive feedback indicator 506 (e.g., user input 128 that contacts the positive feedback indicator 506, user input 128 that is in a general direction of the positive feedback indicator 506, and so forth). The second configuration 504 illustrates the result of the user input 128 indicating interest in the item 118. In this second configuration 504, the computing device 104 displays an additional item 406 represented by a gaming controller icon. As described above with respect to FIG. 4, the additional item 406 replaces the previous item 118, representing the next item in the item sequence 202.

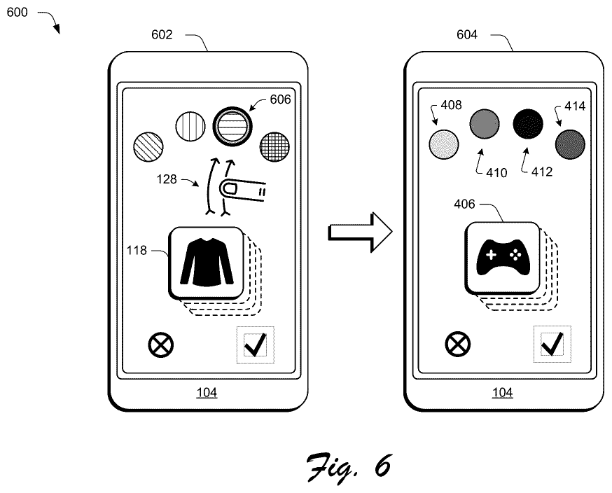

FIG. 6 depicts a system 600 in an example implementation of receiving user input 128 to the swipeable user interface 114 and modifying the swipeable user interface 114 based on the user input 128. In the illustrated example of FIG. 6, computing device 104 is depicted as outputting a first configuration 602 and a second configuration 604 of the swipeable user interface 114. In the first configuration 602, the computing device 104 displays an item 118 and receives user input 128 relative to the item 118.

The first configuration 602 introduces a visual indicator 606, depicted as a highlighted circular element among the configurable aspect options. This visual indicator 606 provides feedback to a user of the computing device 104 that the user input 128 is interpreted as corresponding to the configurable aspect option distinguished from other configurable aspect options by the visual indicator 606. Although depicted as being output in an example format in the example of FIG. 6, the described techniques are not so limited, and the personalization system 110 is configured to generate the visual indicator 606 in any suitable manner to inform a user as to how user input 128 is being interpreted relative to elements of the swipeable user interface 114.

The second configuration 604 illustrates the result of the user input 128 indicating interest in the item 118 and the configurable aspect option highlighted by visual indicator 606. In this second configuration 604, the computing device 104 displays an additional item 406 represented by a gaming controller icon. As described above with respect to FIGS. 4 and 5, the additional item 406 replaces the previous item 118, representing the next item in the item sequence 202.

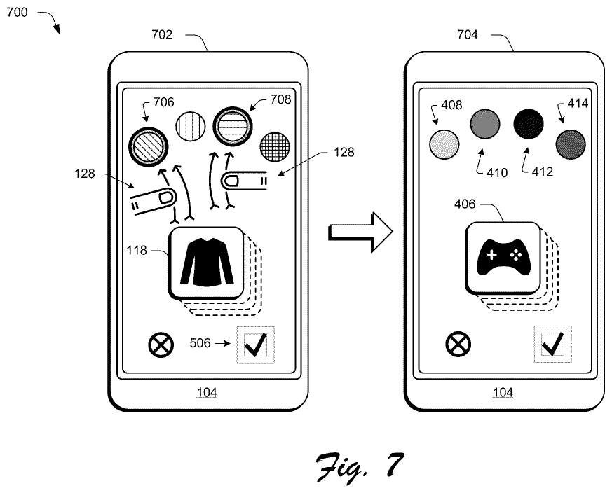

FIG. 7 depicts a system 700 in an example implementation of receiving user input 128 to the swipeable user interface 114 and modifying the swipeable user interface 114 based on the user input 128. In the illustrated example of FIG. 7, computing device 104 is depicted as outputting a first configuration 702 and a second configuration 704 of the swipeable user interface 114. In the first configuration 702, the computing device 104 displays an item 118 and receives user input 128 relative to the item 118.

The first configuration 702 is depicted as displaying visual indicator 706 and visual indicator 708, depicted as highlighted circular elements among the configurable aspect options for item 118. These visual indicators provide feedback to a user of the computing device 104 that the user input 128 is interpreted as corresponding to multiple configurable aspect options (e.g., as visually distinguished from other configurable aspect options). In this manner, the swipeable user interface 114 allows users to explicitly specify preferences relative to multiple configurable aspect options for an item 118.

In such implementations, the personalization system 110 is configured to wait until a subsequent input relative to a feedback indicator (e.g., negative feedback indicator 306 or positive feedback indicator 506) is received before transitioning from the first configuration 702 to second configuration 704 of the swipeable user interface 114. This approach allows users to select multiple configurable aspect options before indicating their overall preference for the item.

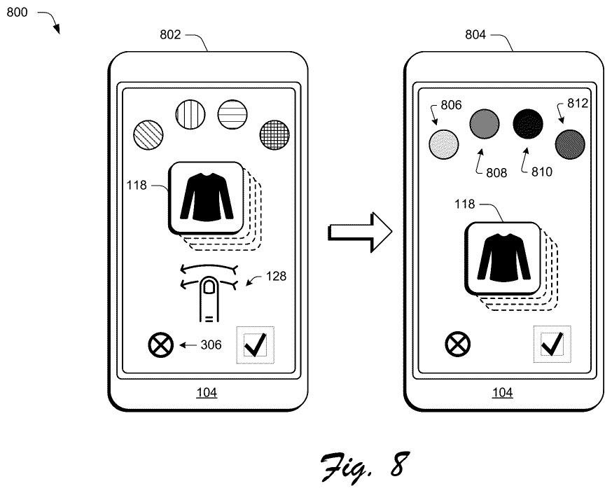

The second configuration 704 illustrates the result of the user input 128 indicating interest in the item 118 and the specific configurable aspect options highlighted by visual indicators 706 and 708. In this second configuration 604, the computing device 104 displays an additional item 406 represented by a gaming controller icon. As described above with respect to FIGS. 4-6, the additional item 406 replaces the previous item 118, representing the next item in the item sequence 202. In some implementations, the personalization system 110 is configured to repeat items in the item sequence 202, such that an item 118 previously displayed in the item sequence 202 with a first set of configurable aspect options is later output as part of the item sequence 202 with a second set of configurable aspect options (e.g., different options 206 to a common configurable aspect 204, options 206 for a different configurable aspect 204, or combinations thereof). For instance, consider FIG. 8.

FIG. 8 depicts a system 800 in an example implementation of receiving user input 128 to the swipeable user interface 114 and modifying the swipeable user interface 114 based on the user input 128. In the illustrated example of FIG. 8, computing device 104 is depicted as outputting a first configuration 802 and a second configuration 804 of the swipeable user interface 114. In the first configuration 802, the computing device 104 displays an item 118 and receives user input 128 relative to the item 118. Specifically, the first configuration 802 depicts a scenario where user input 128 expresses disinterest in the item 118.

In response to receiving the item 118 at the first configuration 802 of the swipeable user interface 114, the personalization system 110 is configured to present the second configuration 804 of the swipeable user interface 114. In the second configuration 804, the swipeable user interface 114 includes a display of item 118, with different configurable aspect options relative to the configurable aspect options that were presented in the first configuration 802.

For instance, the first configuration 802 presented configurable aspect option 120, configurable aspect option 122, configurable aspect option 124, and configurable aspect option 126, representing different patterns for the item 118. In contrast to the first configuration 802, the second configuration 804 presents configurable aspect option 806, configurable aspect option 808, configurable aspect option 810, and configurable aspect option 812, which individually represent different colors for the item 118.

In this manner, the swipeable user interface 114 is configurable to present different sets of configurable aspect options for the same item 118 in response to user input 128 indicating interest or disinterest in an item 118 or configurable aspect options for the item 118. For instance, if a user expresses disinterest in the item 118 when presented with a first set of configurable aspect options, the personalization system 110 may be configured to re-present the item 118 with a second, different set of configurable aspect options. This approach allows the system to explore potential combinations of item attributes that might appeal to the user, rather than dismissing the item entirely based on a single set of options.

The personalization system 110 may implement this feature by maintaining a database of multiple configurable aspect options for each item 118. When user input 128 indicates disinterest in an item with its initially presented configurable aspect options, the system may select an alternative set of options from this database. This process can be repeated multiple times, cycling through different combinations of configurable aspect options for the item 118 until either user interest is captured or a predetermined threshold of attempts is reached.

By employing this iterative presentation strategy, the personalization system 110 avoids potentially mischaracterizing user preferences based on limited feedback. Instead of assuming that negative feedback on one set of configurable aspect options applies universally to the item 118, the personalization system 110 recognizes that user interest may be contingent on specific attribute combinations. This nuanced approach enhances the accuracy of the personalization process and increases the likelihood of identifying items and configurations that truly align with user preferences.

Further, this configurable aspect option cycling mechanism allows the personalization system 110 to gather more comprehensive data about user preferences. Each interaction with a different set of configurable aspect options for the same item 118 provides additional data points for inclusion in selection data 208, and ultimately for consideration in generating the personalized style 132.

Returning to FIG. 2, the selection data 208 is provided as input to the personalization system 110. The personalization system 110 includes an item weighting module 210, which represents functionality of the personalization system 110 to process the selection data 208 and generate weighted item aspects 212. The weighted item aspects 212 include data for each item 118 in the item sequence 202. For each item 118, the weighted item aspects 212 include information describing at least some configurable aspects 204 of the item 118, and data describing user feedback relative to one or more options 206 for each configurable aspect 204. The data describing user feedback relative to an individual option 206 is depicted in FIG. 2 as option weight 214. The option weight 214 thus represents a mathematical value assigned to each configurable aspect option based on the user input 128, indicating the strength of preference or dislike.

The item weighting module 210 is configured to generate weighted item aspects 212 using various techniques. In some implementations, the item weighting module 210 assigns numerical values to each configurable aspect option 206 based on a direction and distance of a user's swipe gesture received via user input 128. For instance, a swipe towards a specific configurable aspect option may result in a positive weight, while a swipe away from an option may result in a negative weight. The magnitude of the weight may be determined by the distance of the swipe, with longer swipes indicating stronger preferences. This approach allows for a nuanced capture of user sentiment, translating physical interactions into quantifiable data.

In other implementations, the item weighting module 210 employs a time-based weighting system. The duration a user spends interacting with or hovering over a particular configurable aspect option before making a selection may influence the assigned weight. Longer interaction times may result in higher weights, reflecting a user's increased interest or deliberation. This captures not just the final selection, but also the decision-making process, providing richer data for personalization. Some implementations of the item weighting module 210 incorporate multi-touch gestures to generate weighted item aspects 212. For example, using two fingers to swipe towards a configurable aspect option could indicate a stronger preference than a single-finger swipe, resulting in a higher option weight 214. Similarly, pinch-to-zoom gestures on specific options could be interpreted as increased interest, with the degree of zoom correlating to the assigned weight. This approach leverages more complex user interactions to derive more detailed preference information.

The item weighting module 210 is further configured to utilize contextual information to adjust option weights 214. For instance, if a user consistently shows preference for a particular attribute across multiple items (e.g., always swiping towards blue-colored options 206), the item weighting module 210 is configured to apply higher weights to similar options in subsequent items. This adaptive weighting system allows for the capture of broader style preferences that extend beyond individual items, enhancing the overall capabilities of the personalization system 110. In some implementations, the item weighting module 210 is configured to implement a comparative weighting system. When multiple configurable aspect options are presented simultaneously, the order in which a user interacts with them is useable to influence relative option weights 214. For example, options selected first may receive higher weights, reflecting their priority in the user's decision-making process. This allows for the capture of not just absolute preferences, but also the relative importance of different attributes to the user.

The encoding module 216 generates the feedback encoding 130 by processing the weighted item aspects 212. In one implementation, the encoding module 216 generates the feedback encoding 130 using a binary encoding scheme. Each configurable aspect option is assigned at least one bit in a binary string, with the value of the bit (0 or 1) determined by whether the option weight 214 meets a certain threshold. Alternatively or additionally, the encoding module 216 is configured to utilize a multi-level encoding scheme. Instead of simple binary values, the option weights 214 are mapped to a range of values (e.g., 0-3, representing strong dislike, mild dislike, mild like, and strong like). This encoding allows for more granular representation of user preferences while still maintaining a compact data format. The resulting feedback encoding 130 is a string of multi-level values, providing more nuanced data for the personalization system 110 to understand user preferences.

In some implementations, the encoding module 216 may employ a differential encoding technique. Rather than encoding absolute weights, differences in weights between consecutive configurable aspect options or items are encoded. This approach is useful in capturing trends or changes in user preferences across a items in the item sequence 202, revealing insights regarding how a user's tastes evolve during interaction with the swipeable user interface 114. In implementations, the feedback encoding 130 is output in various data formats, such as a binary string, JSON object, or other suitable representations that capture the user's preferences across multiple items and their attributes. The feedback encoding 130 is then useable by the personalization system 110 to generate a personalized style 132 for a user of the computing device 104.

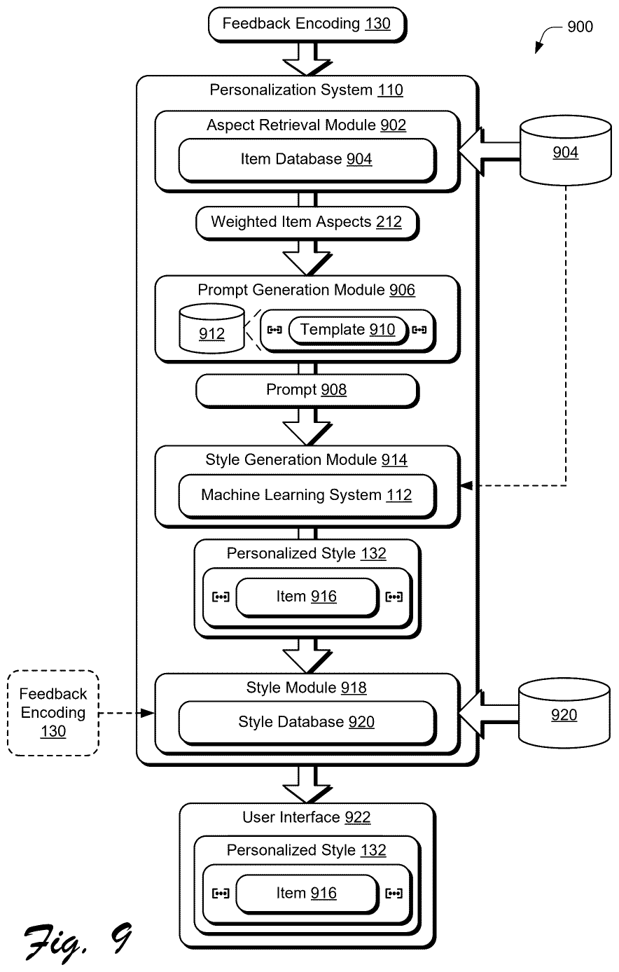

FIG. 9 depicts a system 900 in an example implementation showing operation of the personalization system 110 in greater detail as generating a personalized style 132 based on user input to the swipeable user interface 114. In the illustrated example of FIG. 9, the personalization system 110 includes an aspect retrieval module 902. The aspect retrieval module 902 represents functionality of the personalization system 110 to retrieve information corresponding to each instance of digital content from which the feedback encoding 130 is generated. For instance, in the example context of digital content representing items for sale on a digital marketplace service offered by the service provider system 102, the aspect retrieval module 902 is configured to query an item database 904 to identify item aspects associated with each of the instances of digital content referenced in the feedback encoding 130.

In some implementations, the feedback encoding 130 corresponds to a defined sequence of digital content items, such that different users are presented with the same sequence of cards in a deck of cards (e.g., the deck of cards including the item 118). In this manner, the aspect retrieval module 902 is informed by the personalization system 110 as to a specific instance of digital content that corresponds to respective values or strings of values in the feedback encoding 130. In implementations, the personalization system 110 provides the aspect retrieval module 902 with an item identifier of an item offered for sale via a digital marketplace, where each item identifier corresponds to a representation of the respective item as displayed in the deck of cards presented via the swipeable user interface 114. The aspect retrieval module 902 is configured to compare each item identifier to entries in the item database 904. Entries in the item database 904 represent individual items and metadata that describes aspects of the item (e.g., title, category identifier, item description parameters, price, and so forth).

The aspect retrieval module 902 is configured to output weighted item aspects 212 (e.g., as previously generated by the item weighting module 210, as generated by the aspect retrieval module 902 using information retrieved from the item database 904, or combinations thereof). For instance, in an example scenario where a configurable aspect option for an item represented by an instance of digital content is associated with a value in the feedback encoding 130 indicating positive sentiment, the aspect retrieval module 902 is configured to assign a mathematical weight to attributes associated with the item, where the mathematical weights indicate that positive sentiment is associated with the specific item attributes.

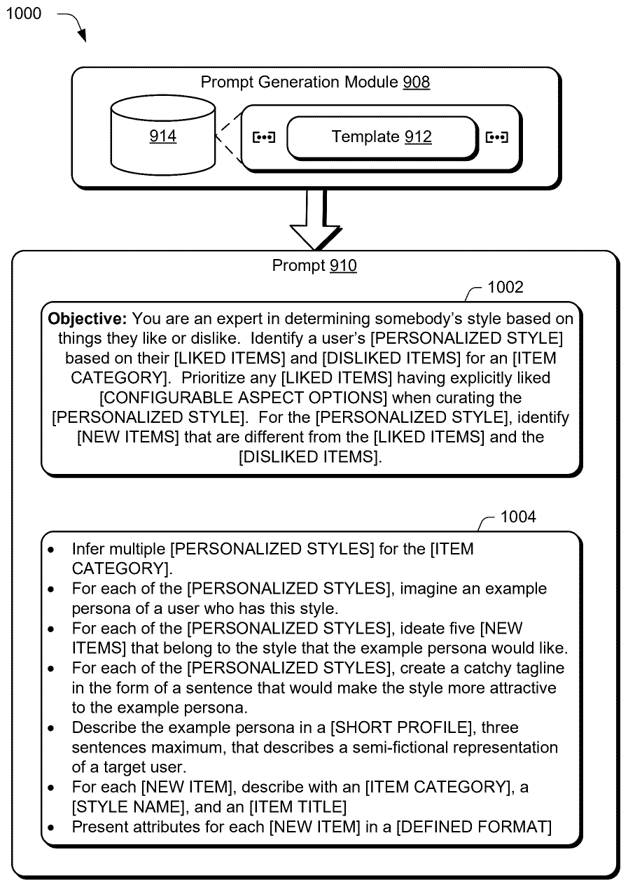

The weighted item aspects 212 are provided as input to a prompt generation module 906 to generate a prompt 908. The prompt 908 is configured to initiate generation of the personalized style 132 based on the feedback encoding 130 (e.g., the weighted item aspects 212 represented by the feedback encoding 130) using one or more machine learning models of the machine learning system 112. The prompt generation module 906 is configured to do so by leveraging one or more templates 910 (illustrated as stored in storage device 912) that are “filled in” by the prompt generation module 906 (e.g., using natural language processing). A specific example of the prompt generation module 906 generating the prompt 908 by filling in one or more templates 910 is described in further detail below with respect to FIG. 10.

The prompt 908 is then provided as input to a style generation module 914, which represents functionality of the personalization system 110 to output the personalized style 132 using one or more trained machine learning models of the machine learning system 112 (e.g., at least one LLM as described in further detail below with respect to FIG. 11).

FIG. 10 depicts a system 1000 in an example implementation showing operation of the prompt generation module 906 in greater detail as generating prompt 908 based on weighted item aspects 212 represented in the feedback encoding 130. In the illustrated example of FIG. 10, the text of the prompt 908 differentiates text of a template 910 from text input by the prompt generation module 906 (e.g., based on the feedback encoding 130 and/or the weighted item aspects 212) using brackets. For instance, the prompt generation module 906 generates the prompt 908 by inserting text describing the weighted item aspects 212 at positions of the one or more templates 910 enclosed by brackets.

The prompt 908, for instance, is depicted as defining the following objective for the style generation module 914 using a first template 1002: “You are an expert in determining somebody's style based on things they like or dislike. Identify a user's [PERSONALIZED STYLE] based on their [LIKED ITEMS] and [DISLIKED ITEMS] for an [ITEM CATEGORY]. Prioritize any [LIKED ITEMS] having explicitly liked [CONFIGURABLE ASPECT OPTIONS] when curating the [PERSONALIZED STYLE]. For the [PERSONALIZED STYLE], identify [NEW ITEMS] that are different from the [LIKED ITEMS] and the [DISLIKED ITEMS].” In this prompt 908, the [PERSONALIZED STYLE] corresponds to the personalized style 132 to be generated by the style generation module 914. The [LIKED ITEMS] and the [DISLIKED ITEMS] correspond to items as represented by individual instances of digital content from which the feedback encoding 130 was generated and [CONFIGURABLE ASPECT OPTIONS] correspond to one or more options 206 for at least one configurable aspect 204 that was selected via input to the swipeable user interface 114. The [ITEM CATEGORY] portion of the first template 1002 is representative of a classification for which the personalized style 132 is generated.

For instance, the personalization system 110 is configured to generate personalized styles 132 for different classifications of digital content, such that a first sequence of digital content representation is presented for a first category (e.g., clothing items), a second sequence of digital content representations is presented for a second category (e.g., household goods), a third sequence of digital content representations is presented for a third category (e.g., sporting equipment), and so forth. In implementations, the [ITEM CATEGORY] corresponding to the item sequence 202 from which the feedback encoding 130 was generated is predefined by the personalization system 110 and communicated to the prompt generation module 906 along with the weighted item aspects 212.

The prompt 908 is further generated to task the style generation module 914 with identifying [NEW ITEMS], that are different from the items represented by instances of digital content items in the stack of cards from which the feedback encoding 130 was generated. In this manner, the prompt 908 instructs the style generation module 914 to identify different items that are likely of interest, based on the positive or negative sentiment indicated in the feedback encoding 130 and the weighted item aspects 212 derived from, or represented by, the feedback encoding 130. In implementations, the style generation module 914 identifies the [NEW ITEMS] based on information included in the item database 904. Alternatively or additionally, the style generation module 914 identifies [NEW ITEMS] using a database other than the item database 904 from which the weighted item aspects 212 were derived.

The prompt 908 is further refined using a second template 1004, which constrains a structure of the personalized style 132 as output by the style generation module 914. Specifically, the second template 1004 ensures that the style generation module 914 is instructed to infer multiple [PERSONALIZED STYLES] for the [ITEM CATEGORY]. The second template 1004 further instructs the style generation module 914, for each of the [PERSONALIZED STYLES], to imagine an example persona of a user who has this style, and to ideate five [NEW ITEMS] that belong to the style that the example persona would like. In this manner, the second template 1004 constrains a number of [NEW ITEMS] that are to be output as part of the personalized style 132 without constraining the style generation module 914 to infer that only a single personalized style 132 exists given the input of the prompt 908.

The second template 1004 further instructs the style generation module 914 to, for each of the [PERSONALIZED STYLES], create a catchy tagline in the form of a sentence that would make the style more attractive to the example persona. The second template 1004 further instructs the style generation module 914 to describe the example persona in a [SHORT PROFILE], three sentences maximum, that describes a semi-fictional representation of a target user. The second template 1004 further instructs the style generation module 914 to generate, for each [NEW ITEM], a description of a corresponding [ITEM CATEGORY], a [STYLE NAME], and an [ITEM TITLE]. Thus, the prompt 908 instructs the style generation module 914 to craft, a tagline designed to appeal to the example persona for which the personalized style 132 is generated. Each new item included in the personalized style 132 will be described with details such as the item category, style name, and item title, along with its attributes (e.g., as derived from the item database 904). Additionally, the second template 1004 instructs the style generation module 914 to present the attributes for each [NEW ITEM] included in a personalized style 132 in a [DEFINED FORMAT]. In implementations, the [DEFINED FORMAT] (e.g., JSON) is designated by the personalization system 110, designated by a user of the service provider system 102, or combinations thereof.

In this manner, the prompt 908 causes the machine learning system 112 implemented by the style generation module 914 to infer preferences based on weighted item aspects when generating a plurality of personalized styles that includes the personalized style 132. For instance, the second template 1004 causes the style generation module 914 to analyze patterns in the weighted item aspects and identify underlying preferences that are not explicitly stated. Example inferred preferences include color schemes, design aesthetics, product categories, price ranges, brands, and other configurable aspect options having positive weights, configurable aspect options that are absent from items with negative weights, or combinations thereof. In some implementations, the style generation module 914 leverages historical data from other users with similar weighted configurable aspect options to make more accurate inferences regarding preferences associated with a personalized style 132. The inferred preferences are useable to identify new items for inclusion in the personalized style 132 that align with an individual's tastes, even if those items differ in some ways from the specific items in the deck of cards from which the feedback encoding 130 was generated.

Returning to FIG. 9, the prompt generation module 906 inputs the prompt 908 (e.g., as filled out using the feedback encoding 130, the weighted item aspects 212, the first template 1002, and the second template 1004) to the style generation module 914. The prompt 908 causes the machine learning system 112 to generate a personalized style 132 including at least one item 916. For instance, in the context of the illustrated example of FIG. 10, at least one item 916 represents one of the five [NEW ITEMS] that the style generation module 914 is tasked to output as part of the personalized style 132. In the example context of a digital marketplace service provided by the service provider system 102, the at least one item 916 corresponds to a digital representation of an item listed for sale at the digital marketplace service.

The personalized style 132, including the at least one item 916 output by the style generation module 914, is communicated to a style module 918 for storage in a style database 920. In implementations, the personalization system 110 is configured to repeat this process of generating a personalized style 132 for each possible combination of values that can be represented by the feedback encoding 130 for an item sequence 202. The different personalized styles 132 are stored in the style database 920 and indexed by the style module 918 based on the corresponding values of the feedback encoding 130 from which the personalized style 132 was generated.

In this manner, the personalization system 110 is configured to quickly identify a personalized style 132 for a feedback encoding 130 received from a computing device 104 and return the personalized style 132 (e.g., for display in a user interface 922 output by the computing device 104). Advantageously, this enables the personalization system 110 to rapidly identify a personalized style 132 that corresponds to a feedback encoding 130 and return the at least one item 916 of the identified personalized style 132 for immediate display in the user interface 922, thereby providing a seamless user experience. Further, by indexing personalized styles 132 stored in the style database 920 using the feedback encoding 130, the personalization system 110 is able to identify a personalized style 132, and at least one item 916 associated therewith, in a manner that requires minimal consumption of computational resources, which is not possible using conventional techniques.

FIG. 11 depicts a system 1100 in an example implementation showing output of a user interface 922 as displaying at least one item 916 of a personalized style 132 generated by the machine learning system 112 based on a prompt 908 generated by the personalization system 110. In the illustrated example of FIG. 11, the style generation module 914 is depicted as using a LLM 1102 of the machine learning system 112 to generate a personalized style 132 based on the input prompt 908. The LLM 1102 is representative of at least one LLM built upon a transformer architecture, such that the LLM 1102 is designed to handle sequential data and natural language processing tasks.

In some implementations, LLM 1102 includes multiple layers of self-attention mechanisms, where each layer contains two main components: a multi-head self-attention mechanism and a feed-forward neural network. The self-attention mechanism enables the LLM 1102 to focus on different parts of an input sequence (e.g., prompt 908) simultaneously, capturing dependencies between words or tokens regardless of their position in the sequence. This LLM architecture is scaled to numerous (e.g., billions or even trillions) of parameters, with layers stacked deeply (e.g., hundreds of layers) to capture complex patterns and representations.

In implementations, a LLM implemented by the style generation module 914 is pre-trained on vast amounts of text data, where the LLM 1102 learns to predict missing or next tokens based on context, leading to the emergence of a rich latent space representation of language. After pre-training, fine-tuning on specific tasks or domain-specific data is utilized to enhance performance for particular applications (e.g., outputting personalized style 132 based on the prompt 908). In implementations, parameters of the LLM 1102 are optimized using variants of stochastic gradient descent (e.g., Adam), making the LLM 1102 capable of handling a wide range of natural language understanding and generation tasks.

An output generated by the LLM 1102, as displayed in the user interface 922, includes a digital content item 1104, which is representative of an instance of digital content that was not presented by the swipeable user interface 114 and is likely to be of interest to a user from which the feedback encoding 130 was received. Specifically, in the illustrated example of FIG. 11, the digital content item 1104 depicts a shirt featuring an image of a dog, identified by the style generation module 914 as being an item 916 included in a personalized style 132 generated based on the prompt 908. The user interface 922 further depicts a tagline 1106, generated as part of the personalized style 132 based on the example prompt 908 described above and illustrated in FIG. 10.

In the context of being displayed as part of a digital marketplace service offered by the service provider system 102, the user interface 922 further includes selectable controls, such as control 1108, control 1110, control 1112, and control 1114. Control 1108 is selectable by a user of the computing device 104 to order a product, represented by the digital content item 1104, offered for sale via the digital marketplace service. Control 1110 is selectable to navigate from a current display of the user interface 922 to information associated with the digital content item 1104, such as a listing page for a product represented by the digital content item 1104. Control 1112 is selectable to display a different item 916 included in the personalized style 132 as generated by the style generation module 914, and control 1114 is selectable to perform one or more functions pertaining to the digital content item 1104, such as to share the digital content item 1104 with another user, save the digital content item 1104 for subsequent viewing, and so forth. Although FIG. 11 depicts the user interface 922 as displaying a single item included in the personalized style 132, the described techniques are not so limited, and the personalization system 110 is configured to cause display of data associated with the personalized style 132 in any suitable manner via the user interface 922. In some implementations, the user interface 922 is representative of the swipeable user interface 114. Alternatively or additionally, the user interface 922 represents a user interface other than the swipeable user interface 114.

Having considered example systems and techniques for generating a personalized style that includes at least one item identified based on input to a swipeable user interface, consider now example procedures to illustrate aspects of the techniques described herein.

### Example Procedures

The following discussion describes techniques that are configured to be implemented utilizing the systems and devices described herein. Aspects of each of the procedures are configured for implementation in hardware, firmware, software, or a combination thereof. The procedures are shown as a set of blocks that specify operations performed by one or more devices and are not limited to the orders shown for performing the operations by the respective blocks. In portions of the following discussion, reference is made to FIGS. 1-11.

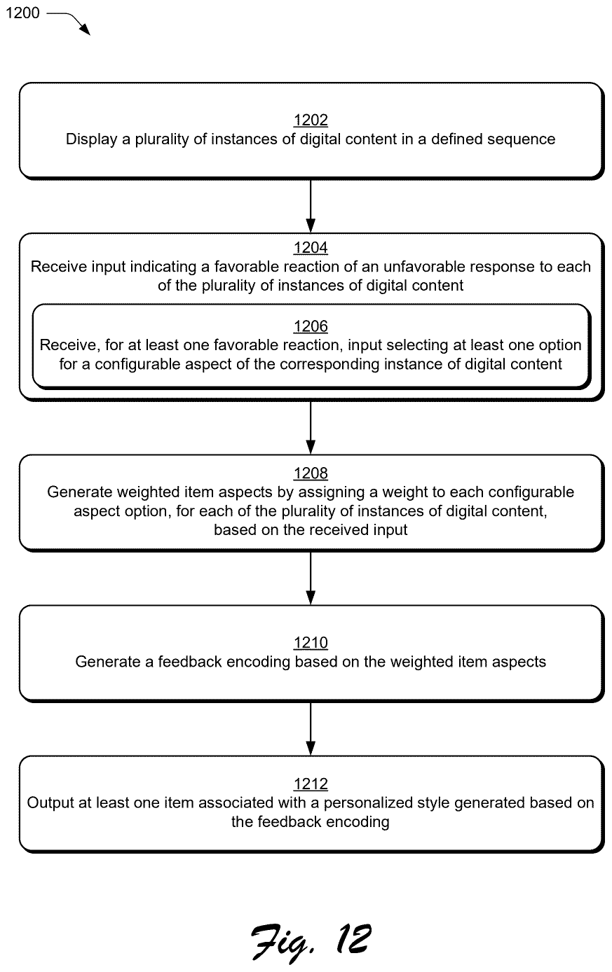

FIG. 12 depicts a procedure 1200 in an example implementation of generating a personalized style based on user input to a swipeable user interface 114. To begin, a plurality of instances of digital content are displayed in a defined sequence (block 1202). The computing device 104, for instance, displays an item sequence 202 in the swipeable user interface 114, where each item 118 represents a different instance of digital content.

Input is then received indicating a favorable reaction or an unfavorable response to each of the plurality of instances of digital content (block 1204). The computing device 104, for instance, receives user input 128 at the swipeable user interface 114 in the form of directional swipe gestures. Within block 1204, for at least one favorable reaction, input selecting at least one option for a configurable aspect of the corresponding instance of digital content is received (block 1206). User input 128, for instance is received via the swipeable user interface 114 selecting at least one of a configurable aspect option 120, configurable aspect option 122, configurable aspect option 124, or configurable aspect option 126 for an item 118.

Weighted item aspects are then generated by assigning a weight to each configurable aspect option, for each of the plurality of instances of digital content, based on the received input (block 1208). The item weighting module 210, for instance, generates weighted item aspects 212 by assigning option weights 214 to each configurable aspect option 206 based on the user input 128.

A feedback encoding is then generated based on the weighted item aspects (block 1210). The encoding module 216, for instance, generates the feedback encoding 130 by processing the weighted item aspects 212.

At least one item associated with a personalized style that is generated based on the feedback encoding is then output (block 1212). The computing device 104, for instance, receives the personalized style 132 from the personalization system 110 and outputs item 916 for display in the user interface 922.

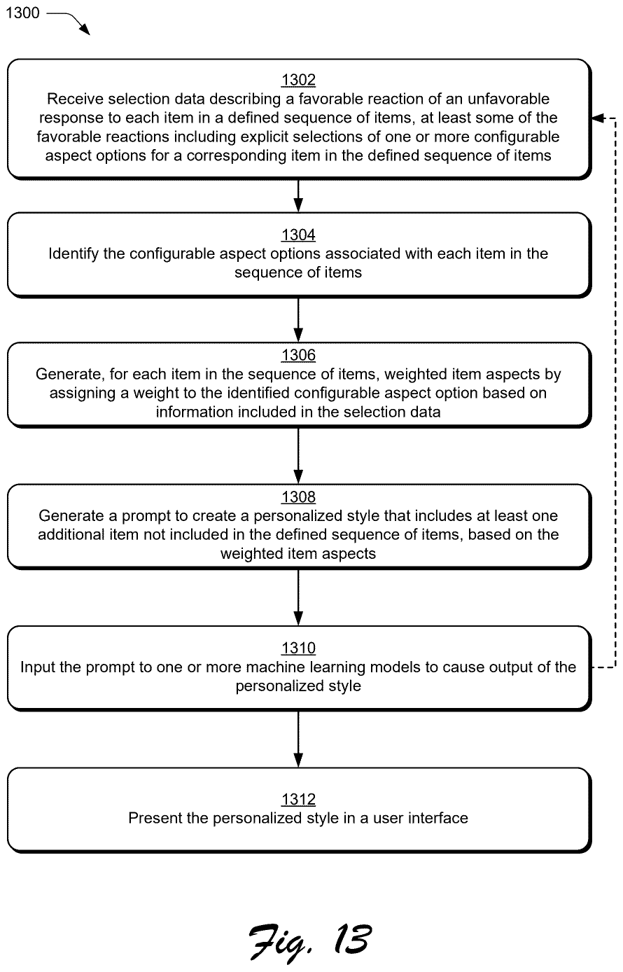

FIG. 13 depicts a procedure 1300 in an example implementation of generating a personalized style based on user input to a swipeable user interface 114. To begin, selection data describing a favorable reaction or an unfavorable response to each item in a defined sequence of items is received, at least some of the favorable reactions including explicit selections of one or more configurable aspect options for a corresponding item in the defined sequence of items (block 1302). The personalization system 110, for instance, receives selection data 208 from the computing device 104.

The configurable aspect options associated with each item in the sequence of items are then identified (block 1304). The aspect retrieval module 902, for instance, identifies configurable aspect options for each item by querying the item database 904. For each item in the sequence of items, weighted item aspects are generated by assigning a weight to the identified configurable aspect option based on information included in the selection data (block 1306). The aspect retrieval module 902, for instance, generates weighted item aspects 212 based on the selection data 208.

A prompt to create a personalized style that includes at least one additional item not included in the defined sequence of items, based on the weighted item aspects, is then generated (block 1308). The prompt generation module 906, for instance, generates prompt 908 using template 910 and the weighted item aspects 212. The prompt is then input to one or more machine learning models to cause output of the personalized style (block 1310). The style generation module 914, for instance, inputs the prompt 908 to the machine learning system 112, which includes LLM 1102, to generate the personalized style 132.

The personalized style is then presented in a user interface (block 1312). The computing device 104, for instance, displays the personalized style 132, including item 916, in the user interface 922. Having described example procedures in accordance with one or more implementations, consider now an example system and device to implement the various techniques described herein.

### Example System and Device

FIG. 14 illustrates an example system 1400 that includes an example computing device 1402 that is representative of one or more computing systems and/or devices that implement the various techniques described herein. This is illustrated through inclusion of the service provider system 102 and the personalization system 110. The computing device 1402 is configurable, for example, as a server of a service provider, a device associated with a client (e.g., a client device), an on-chip system, and/or any other suitable computing device or computing system.

The example computing device 1402 as illustrated includes a processing device 1404, one or more computer-readable media 1406, and one or more I/O interface 1408 that are communicatively coupled, one to another. Although not shown, the computing device 1402 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1404 is representative of functionality to perform one or more operations using hardware. Accordingly, the processing device 1404 is illustrated as including hardware element 1410 that is configurable as processors, functional blocks, and so forth. This includes implementation in hardware as an application specific integrated circuit or other logic device formed using one or more semiconductors. The hardware elements 1410 are not limited by the materials from which they are formed, or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 1406 is illustrated as including memory/storage 1412 that stores instructions that are executable to cause the processing device 1404 to perform operations. The computer-readable storage medium is configured for storing instructions that, responsive to execution by the processing device, causes the processing device to perform operations. The memory/storage 1412 represents memory/storage capacity associated with one or more computer-readable media. The memory/storage 1412 includes volatile media (such as random-access memory (RAM)) and/or nonvolatile media (such as read only memory (ROM), Flash memory, optical disks, magnetic disks, and so forth). The memory/storage 1412 includes fixed media (e.g., RAM, ROM, a fixed hard drive, and so on) as well as removable media (e.g., Flash memory, a removable hard drive, an optical disc, and so forth). The computer-readable media 1406 is configurable in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1402 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1402. By way of example, and not limitation, computer-readable media includes “computer-readable storage media” and “computer-readable signal media.” “Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1402, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1410 and computer-readable media 1406 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1410. The computing device 1402 is configured to implement particular instructions and/or functions corresponding to the software and/or hardware modules. Accordingly, implementation of a module that is executable by the computing device 1402 as software is achieved at least partially in hardware, e.g., through use of computer-readable storage media and/or hardware elements 1410 of the processing device 1404. The instructions and/or functions are executable/operable by one or more articles of manufacture (for example, one or more computing devices 1402 and/or processing devices 1404) to implement techniques, modules, and examples described herein.

The techniques described herein are supported by various configurations of the computing device 1402 and are not limited to the specific examples of the techniques described herein. This functionality is also implementable all or in part through use of a distributed system, such as over a “cloud” 1414 via a platform 1416 as described below.

The cloud 1414 includes and/or is representative of a platform 1416 for resources 1418. The platform 1416 abstracts underlying functionality of hardware (e.g., servers) and software resources of the cloud 1414. The resources 1418 include applications and/or data that can be utilized while computer processing is executed on servers that are remote from the computing device 1402. Resources 1418 can also include services provided over the Internet and/or through a subscriber network, such as a cellular or Wi-Fi network.

The platform 1416 abstracts resources and functions to connect the computing device 1402 with other computing devices. The platform 1416 also serves to abstract scaling of resources to provide a corresponding level of scale to encountered demand for the resources 1418 that are implemented via the platform 1416. Accordingly, in an interconnected device embodiment, implementation of functionality described herein is distributable throughout the system 1400. For example, the functionality is implementable in part on the computing device 1402 as well as via the platform 1416 that abstracts the functionality of the cloud 1414.

In implementations, the platform 1416 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
displaying, in a user interface, an item of a defined sequence of items and different options for a configurable aspect of the item;
receiving input comprising a swipe from the item towards one of the different options for the configurable aspect of the item;
generating, based on the input, weighted item aspects by assigning a weight to each of the different options for the configurable aspect of the item;
generating a personalized style that includes at least one item not included in the defined sequence of items based on the weighted item aspects; and
presenting the personalized style for output via a user interface.

2. The method of claim 1, wherein the different options for the configurable aspect of the item are each displayed at a respective different position in the user interface, wherein each of the respective different positions are similarly distanced from the item as displayed in the user interface.

3. The method of claim 1, further comprising:
displaying an additional item from the defined sequence of items in the user interface;
displaying a negative sentiment icon in the user interface;
receiving an additional input comprising a swipe from the additional item towards the negative sentiment icon; and
generating additional weighted item aspects by assigning a weight to each configurable aspect of the item based on the additional input.

4. The method of claim 1, wherein the item includes multiple different configurable aspects, the method further comprising selecting the configurable aspect of the item from the multiple different configurable aspects based on user data for a user for which the personalized style is generated.

5. The method of claim 1, wherein generating the personalized style comprises generating a prompt to initiate generation of the personalized style based on the weighted item aspects using one or more machine learning models.

6. The method of claim 1, further comprising:
displaying a positive sentiment icon in the user interface;
receiving an additional input comprising a swipe from the item relative to the positive sentiment icon; and
assigning a weight to the one of the different options for the configurable aspect of the item based on the additional input.

7. The method of claim 1, wherein the personalized style includes a plurality of items, and wherein presenting the personalized style comprises displaying the plurality of items within the user interface.

8. The method of claim 1, further comprising:
receiving a selection of the at least one item in the personalized style; and
displaying additional configurable aspect options for the selected at least one item.

9. The method of claim 1, further comprising:
storing the weighted item aspects in association with user data; and
updating the personalized style based on weighted item aspects across multiple user sessions with a service provider system.

10. The method of claim 1, wherein the defined sequence of items is dynamically generated based on previously determined user preferences.

11. The method of claim 1, further comprising:
displaying a visual indicator highlighting the one of the different options for the configurable aspect of the item towards which the swipe was directed.

12. The method of claim 1, wherein generating the personalized style comprises:
identifying common attributes among items with positively weighted options for the configurable aspect; and
selecting new items sharing the common attributes for inclusion in the personalized style.

13. The method of claim 1, wherein presenting the personalized style comprises:
generating a natural language description of the personalized style based on the weighted item aspects; and
displaying the natural language description alongside the at least one item in the user interface.

14. The method of claim 1, further comprising generating a feedback encoding based on the weighted item aspects, the feedback encoding comprising a structured data format that captures positive and negative sentiment with respect to the different options for the configurable aspect of the item, wherein generating the personalized style is performed based on the feedback encoding.

15. A system comprising:
one or more processors; and
a computer-readable storage medium storing instructions that are executable by the one or more processors to perform operations comprising:
generating a feedback encoding that includes data describing weighted item aspects derived from user input to a swipeable user interface that displays at least one item from a sequence of items and different options for a configurable aspect of the at least one item;
generating, based on the feedback encoding, a prompt to initiate generation of a personalized style that includes an item not included in the sequence of items based on the weighted item aspects, using one or more machine learning models;
generating the personalized style using the one or more machine learning models and the prompt; and
presenting the personalized style for output via a user interface.

16. The system of claim 15, the operations further comprising:
displaying, in the swipeable user interface, the at least one item from the sequence of items and the different options for the configurable aspect of the at least one item;
receiving input comprising a swipe from the at least one item towards one of the different options for the configurable aspect of the at least one item; and
generating, based on the input, the weighted item aspects by assigning a weight to each of the different options for the configurable aspect of the item.

17. The system of claim 15, wherein generating the prompt based on the feedback encoding comprises inserting the weighted item aspects describing user input to the at least one item from and the different options for the configurable aspect of the at least one item into a template configured for input to the one or more machine learning models.

18. The system of claim 15, wherein generating the personalized style comprises causing the one or more machine learning models to infer preferences based on the feedback encoding.

19. The system of claim 15, wherein the personalized style includes a plurality of items, and wherein presenting the personalized style comprises displaying the plurality of items within the user interface.

20. A computer-readable storage medium storing instructions that are executable by at least one processing device to perform operations comprising:
displaying, in a user interface, an item of a defined sequence of items and different options for a configurable aspect of the item;
receiving input comprising a swipe from the item towards one of the different options for the configurable aspect of the item;
generating, based on the input, weighted item aspects by assigning a weight to each of the different options for the configurable aspect of the item;
generating a personalized style that includes at least one item not included in the defined sequence of items based on the weighted item aspects; and
presenting the personalized style for output via a user interface.
